(19) United States
(12) Patent Application Publication
(10) Pub. No.: US 2012/0012717 A1
(43) Pub. Date: Jan. 19, 2012

(54) Musical Instrument Stand

(76) Inventor: Jonathan David Mason, Tallahassee, FL (US)

(21) Appl. No.: 12/838,045

(22) Filed: Jul. 16, 2010

(51) Int. Cl. F16M 11/10

(52) U.S. Cl. 248/122.1; 248/121

(57) ABSTRACT

The present invention comprises a stand for a musical instrument, such as a guitar. The stand is primarily comprised of a first plate, a second plate, a top holder and two bottom supports. The first plate is attached to the back of the body of the instrument. The second plate is pivotally attached to the first plate. The top holder is attached to the top of the first plate at a first end and extends up and over the top of the body of the instrument. Two bottom supports extend from the bottom of the first plate down and under the body of the instrument. When the second plate pivots away from the first plate when the stand is in use, the second plate and the two bottom supports fully support said guitar in an upright position.

### CROSS-REFERENCES TO RELATED APPLICATIONS

Not Applicable

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to an apparatus for supporting a musical instrument when it is not in use. More specifically, the invention comprises an apparatus which attaches to a musical instrument such that the apparatus can hold the musical instrument upright when it is not in use and can be stored along with the instrument.

2. Description of the Related Art

Musical instruments are expensive devices and should be stored safely when not in use. Specifically, instruments in the chordophone family, or stringed instruments, are stored primarily using either cases or stands. Stands for stringed instruments are known in the prior art. For example, guitar stands are used to hold a guitar safely while it is not in use. FIG. 1 illustrates a prior art guitar stand 52 that holds the guitar 12 in an upright position. The guitar body 14 sits on two prior art bottom supports 58. The guitar neck 36 leans against the prior art neck support 56. The prior art stand 52 has a prior art stem 62 which attaches at the base to prior art legs 62. Prior art legs 62 support the stand 52 and ultimately the guitar 12.

Musicians typically travel and carry their equipment to different venues, practices or lessons. Thus, guitar stands often travel with them. Guitar stands can be bulky and difficult to travel with. They do not fit inside of a guitar case and they can be difficult to set up and take down when the guitarist is in a hurry. Additionally, the guitar stand may be difficult to find on a dark stage in between sets.

Therefore what is needed is an apparatus which allows a user to easily support a stringed instrument when the instrument is not in use, while being easy to set up and store for transporting. The present invention achieves this objective, as well as others that are explained in the following description.

### BRIEF SUMMARY OF THE INVENTION

The present invention comprises a stand for a musical instrument, such as a guitar. The stand is primarily comprised of a first plate, a second plate, a top holder and two bottom supports. The first plate is removably attached to the back of the body of the instrument. The second plate is pivotally attached to the first plate. The top holder is attached to the top of the first plate at a first end and extends up and over the top of the body of the instrument. Two bottom supports extend from the bottom of the first plate down and under the body of the instrument.

When the second plate pivots away from the first plate when the stand is in use, the second plate and the two bottom supports fully support said guitar in an upright position.

### BRIEF DESCRIPTION OF THE SEVERAL VIEWS OF THE DRAWINGS

FIG. 1 is a perspective view, showing a prior art guitar stand holding a guitar.

FIG. 2 is a perspective view, showing the back of a guitar with the present invention attached thereto.

FIG. 3 is a perspective view, showing the present invention.

FIG. 4 is a side view, showing the support plate extended away from the first plate of the present invention.

FIG. 5 is a perspective view, showing the adjustable rubber strap and top holder of the present invention.

FIG. 6 is a perspective view, showing an alternate embodiment for an adjustable mechanism and the top holder of the present invention.

FIG. 7 is a perspective view, showing the present invention detached from a musical instrument.

FIG. 8 is a cross section, showing the bottom holder with attached rubber foot of the present invention.

FIG. 9 is an alternate embodiment of the present invention.

### REFERENCE NUMERALS IN THE DRAWINGS

| | | | |
|---|---|---|---|
| 10 | present stand | 12 | guitar |
| 14 | body | 16 | support plate |
| 18 | adjustable strap | 20 | top holder |
| 22 | movable hinge | 24 | bottom support |
| 26 | rubber feet | 28 | first plate |
| 30 | top hinge | 32 | cut-away |
| 34 | handle (indent) | 36 | neck |
| 38 | strap peg | 40 | bottom lip |
| 42 | upper lip | 44 | adjustable strap |
| 46 | adjustable strap | 48 | flat head bolt |
| 50 | nut | 52 | prior art stand |
| 54 | prior art base | 56 | prior art neck support |
| 58 | prior art bottom supports | 60 | prior art legs |
| 62 | prior art stem | 64 | ground |
| 66 | first end | 68 | second end |
| 70 | first end | 72 | mid-section |
| 74 | second end | | |

### DETAILED DESCRIPTION OF THE INVENTION

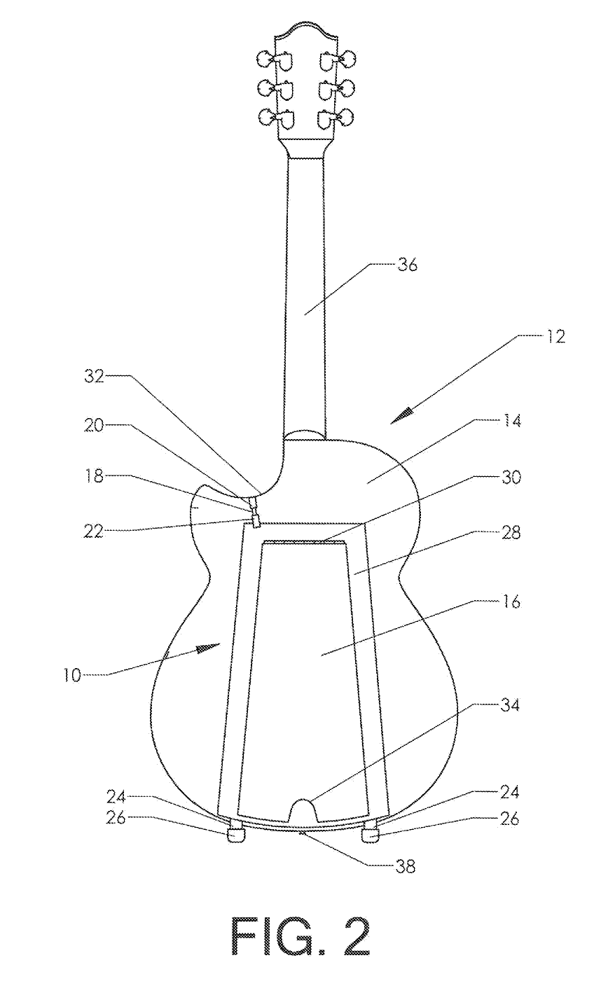

FIG. 2 illustrates the present stand 10 in the preferred embodiment attached to the back of guitar 12. While a guitar 12 is illustrated, the present stand 10 could attach and be used in connection with most stringed instruments.

The present stand 10 is generally made up of first plate 28, second plate 16, top holder 20 and bottom supports 24. First plate 28 and second plate 16 are preferably encased in rubber or a similar material such that first plate 28 and second plate 16 do not damage guitar 12 in any way.

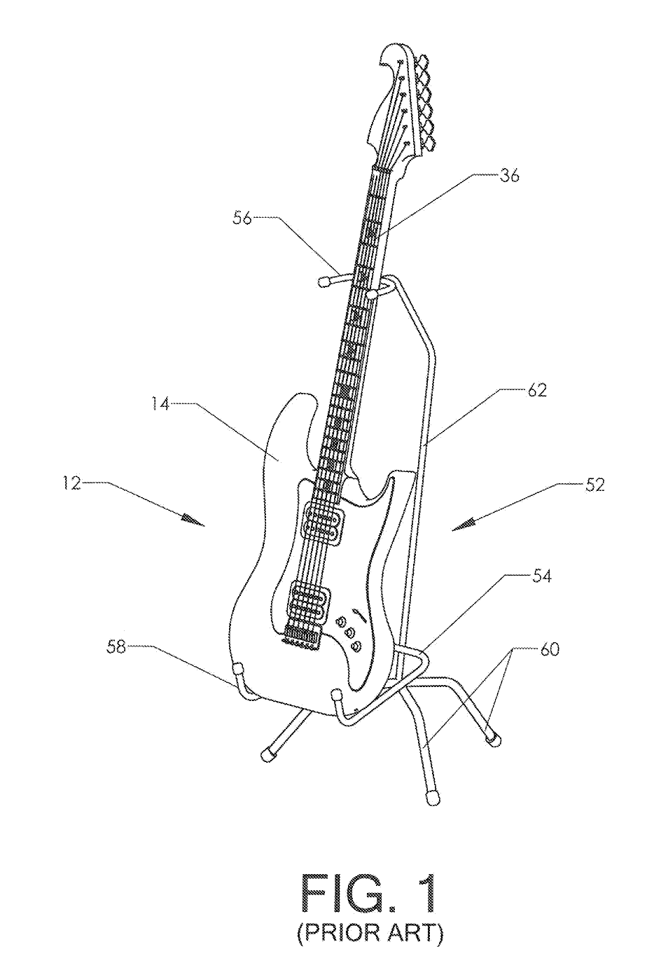

Stand 10 enables guitar 12 to sit upright when not in use without the use of a free floating stand 52 (see FIG. 1, prior art guitar stand). In the preferred embodiment, stand 10 is attached to guitar 12 in such a manner that the user can keep stand 10 attached to guitar 12 at all times, including when the user plays the guitar or stores the guitar. In the alternative stand 10 can be easily taken on and off of guitar 12.

First plate 28 sits flat against the back of body 14 of guitar 12. First plate 28 is held flush against body 14 by way of the forces produced by top holder 20 and bottom supports 24. Top holder 20 attaches to the top of first plate 28 at movable hinge 22. Movable hinge 22 allows top holder 20 to be positioned at varying angles extending away from first plate 28. Top holder 20 hooks over body 14, preferably at cut away 32. Once top holder 20 is hooked over body 14, an optional adjustable strap 18 could be used to tighten top holder 20 to first plate 28 acting to pull first plate 28 closer to back of body 14 of guitar 12.

Bottom supports 24 attach to the bottom of first plate 28, extending down and under body 14 of guitar 12. Bottom support 24 can also include a tightening device in order to tighten bottom supports 24 closer to first plate 28, and effectively tighten first plate 28 closer to back of body 14 of guitar. Bottom supports 24 have domed shaped feet 26 which attach such that feet 26 extend further out than strap peg 38. Feet 26 prevent strap peg 38 from coming into contact with the ground, while providing a secure support for stand 10. While dome-shaped feet 26 are disclosed in the preferred embodiment, any type of feet 26 which extend out further than strap peg 38 could be used.

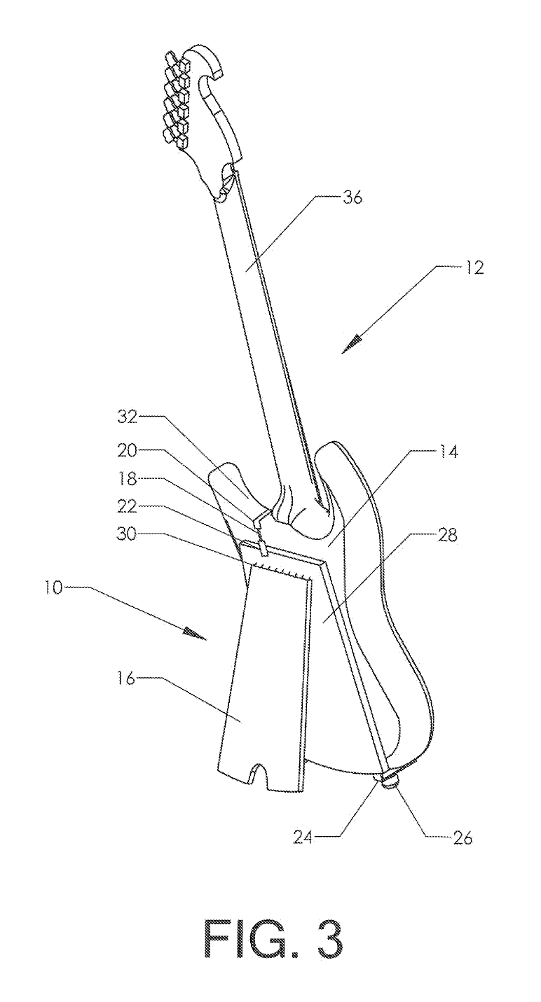

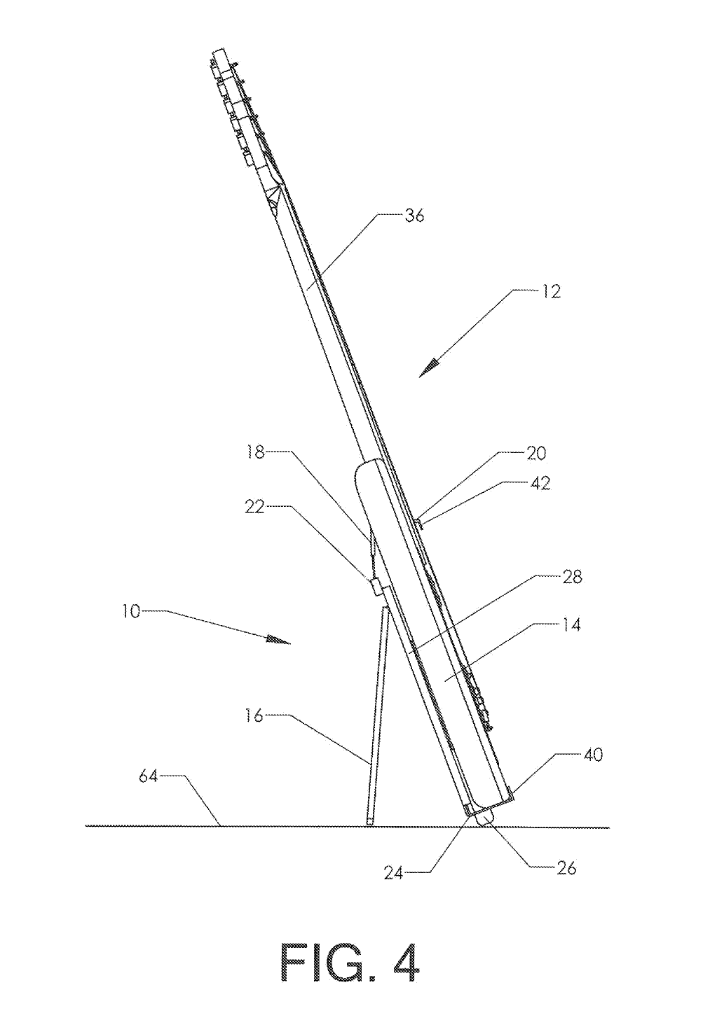

FIGS. 3 and 4 illustrate the manner in which stand 10 supports guitar 12 in an upright position. As illustrated, when not in use, guitar 12 can be set down on feet 26. Second plate 16 is then pulled out away from first plate 28 and contacts ground 24, supporting guitar 12. As shown in the side view of FIG. 4, guitar 12 is supported at its base by bottom support 24. Bottom support 24 includes feet 26 and front lip 40. Front lip 40 holds top holder 20 in place and acts to keep body 14 of guitar 12 from slipping off of the front of stand 10. Additionally, top holder 20 includes a front lip 42 which holds top holder 20 in place and stabilizes body 14 of guitar 12. The utility of dome-shaped feet 26 is shown in FIG. 4. As stand 10 tilts backwards towards second plate 16, feet 26 remain in contact with floor at all times due to the multiple contact points created by the dome-shape of feet 26.

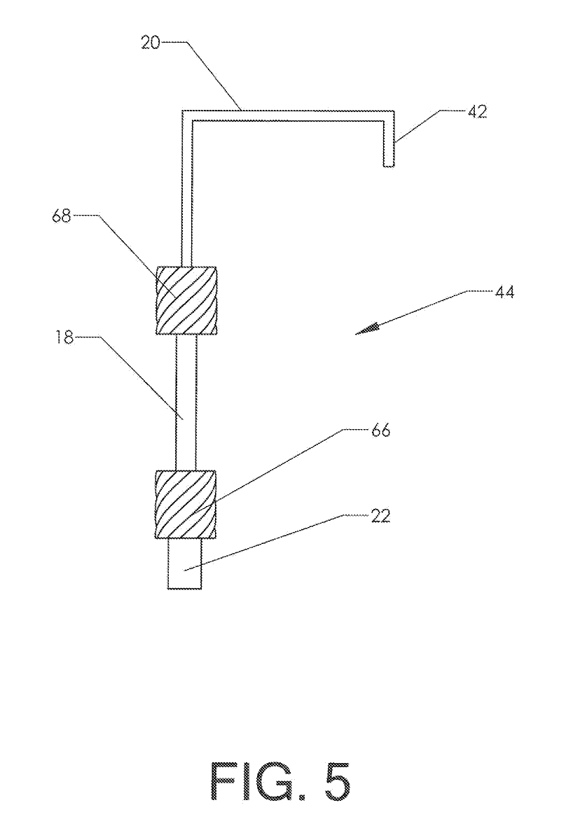

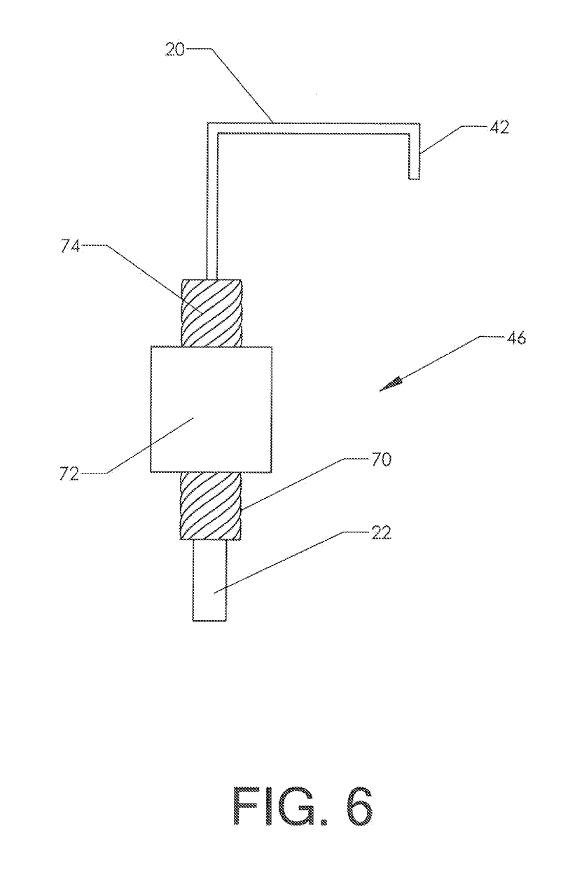

FIGS. 5 and 6 illustrate top holder 20 attached to two different embodiments for adjustable devices 44, 46. In FIG. 5, adjustable device 44 is attached to movable hinge 20 at first end 66 and top holder 20 at second end 68. Adjustable strap 18 moves between first end 66 and second end 68 in order to shorten or lengthen the distance between first end 66 and second end 68. In the alternate embodiment of adjustable device 46, illustrated in FIG. 6, first end 70 is connected to top holder 20 and second end 74 is attached to movable hinge 22. To tighten adjustable device 46, first end 70 and second end 74 twist into mid-section 72, thereby shortening the space between top holder 20 and movable hinge 22. The ultimate purpose of adjustable devices 44, 46 is to pull first plate 28 secure against body 14 of guitar 16 (as shown in FIG. 1 and 2). While two adjustable devices 44, 46 have been illustrated, any known method of adjusting a distance between two points could be used. It is preferable that the adjustable device conform as much as possible to the back of body 14 of guitar 12.

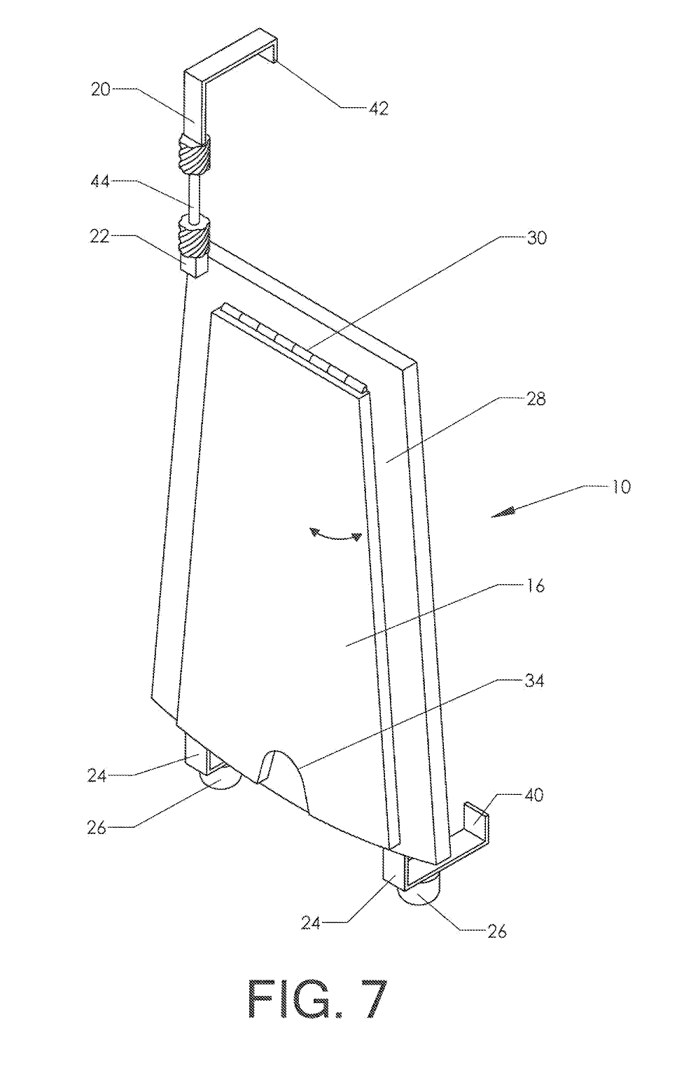

Stand 10 is illustrated in FIG. 7, apart from a musical instrument. Due to the fact that stand 10 is relatively flat, stand 10 can be easily transported while either attached or detached from a musical instrument. This figure also shows the pivotal attachment of second plate 16 to first plate 28 at hinge 30. The two way arrow shows the angle of rotation which hinge 30 permits second plate 16 to move about. It is preferably that hinge 30 includes a stop which prevents second plate 16 from rotating beyond a set angular displacement. An optional indent 34 is shown on second plate 16 which allows second plate 16 to pull easily away from first plate 28 when stand 10 is ready to be used.

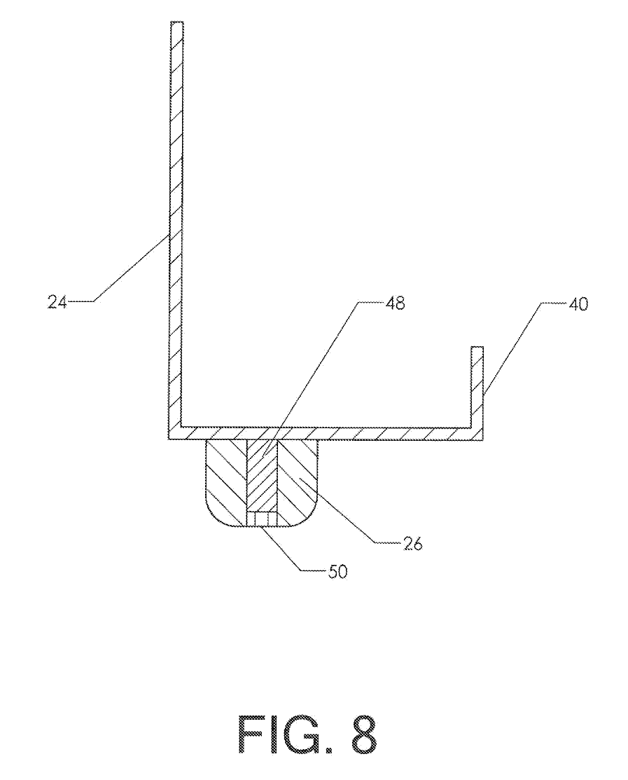

A cross-section of bottom support 24 is illustrated in FIG. 8. Bottom support 26 is preferably “L” shaped and ends in a front lip 40. Foot 26 is preferably dome-shaped and attaches to bottom support 24. Foot 26 can attach to bottom support 24 by any known method. In the preferred embodiment, foot 26 is secured to bottom support 24 by bolt 48 which is welded onto bottom support 24. In the alternative bolt 48 can travels down through bottom support 26 and into foot 26. In this embodiment nut 50 secures foot 26 to bolt 48. While any known method can be employed to attach foot 26 to bottom support 24 it is important that bolt 48 does not scratch the bottom of guitar.

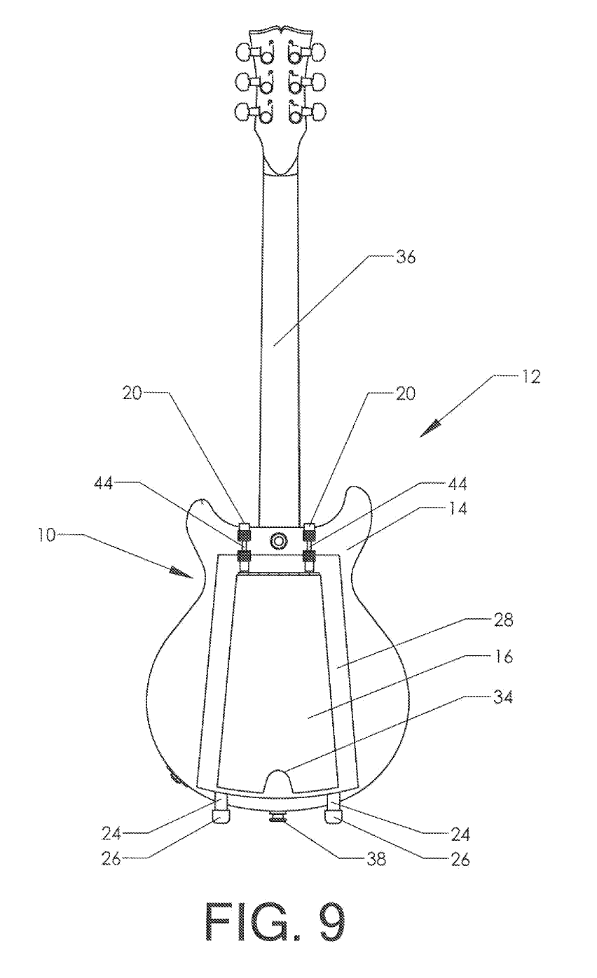

An alternate embodiment of stand 10 is shown in FIG. 9. Stand 10 is designed to attach to guitar 12, even where body 14 of guitar 12 does not include a cut-away. In the alternate embodiment, the top of first plate 28 has two adjustable devices 44 and top holders 20 which hook around both sides of neck 36 of guitar 12.

The preceding description contains significant detail regarding the novel aspects of the present invention. It should not be construed, however, as limiting the scope of the invention but rather as providing illustrations of the preferred embodiments of the invention. As an example, feet 26 could be rectangular in shape as opposed to dome-shaped. Additionally, any type of adjustable device 44, 46 could be used to tighten or loosen first plate 28 to the back of guitar 12. Thus, the scope of the invention should be fixed by the following claims, rather than by the examples given.

Having described my invention, I claim:

1. A stand, for a musical instrument, said musical instrument having a body, a neck, a back and a front, comprising:
a. a first plate attached to said back of said musical instrument, having a top and a bottom;
b. a second plate pivotally attached to said first plate;
c. a top holder attached to said top of said first plate, wherein said top holder is configured to hook over said body of said musical instrument;
d. at least one bottom support attached to said bottom of said first plate, wherein said bottom support is configured to hook under said body of said musical instrument; and
e. wherein said second plate pivots away from said first plate to support said musical instrument in an upright position.

2. A stand as recited in claim 1, wherein said musical instrument is a guitar.

3. A stand as recited in claim 2, wherein said top holder is configured to hook over said cut away of said body of said guitar.

4. A stand as recited in claim 3, wherein said bottom support is configured to hook under said body of said guitar.

5. A stand as recited in claim 1, further comprising at least one bottom foot attached to said at least one bottom support.

6. A stand as recited in claim 5, wherein said at least one bottom foot is a half-domed shape.

7. A stand as recited in claim 5, wherein said at least one bottom foot is rubber.

8. A stand as recited in claim 1, further comprising an adjustable device having a first end and a second end, wherein said first end of said adjustable device is attached to said first plate and wherein said second end of said adjustable device is attached to said top holder.

9. A stand as recited in claim 8, wherein said adjustable device is an adjustable rubber strap.

10. A stand as recited in claim 8, wherein said adjustable device pivots at said first plate.

11. A stand, for a guitar, wherein said guitar has a body, a neck and a cut away, wherein said body of said guitar has a back and a front, comprising:
a. a first plate removably attached to said back of said body of said guitar;
b. a second plate pivotally attached to said first plate;
c. a top holder attached to said first plate, wherein said top holder is configured to hook over said top of said musical instrument at said cut away;
d. two bottom supports attached to said base of said first plate, wherein said bottom support is configured to extend down away from said base of said first plate and hook under said body of said guitar; and
e. wherein said second plate pivots away from said first plate such that when said stand is in use said second plate and said two bottom supports fully support said guitar in an upright position.

12. A stand as recited in claim 11, wherein said second plate pivotally attaches to said first plate at a hinge.

13. A stand as recited in claim 11, further comprising two bottom feet attached to said two bottom supports.

14. A stand as recited in claim 13, wherein said two bottom feet are a half-domed shape.

15. A stand as recited in claim 13, wherein said two bottom feet are made of rubber.

16. A stand as recited in claim 13, wherein a bolt attaches said two bottom feet to said two bottom supports.

17. A stand as recited in claim 11, further comprising an adjustable device having a first end and a second end, wherein said first end of said adjustable device is attached to said first plate and wherein said second end of said adjustable device is attached to said top holder.

18. A stand as recited in claim 17, wherein said adjustable device is an adjustable rubber strap.

19. A stand as recited in claim 17, wherein said adjustable device pivots at said first plate.

20. A stand, for a guitar, wherein said guitar has a body and a neck, wherein said body of said guitar has a back and a front, comprising:
a. a first plate removably attached to said back of said body of said guitar;
b. a second plate pivotally attached to said first plate;
c. a top holder attached to said first plate, wherein said top holder is configured to hook over said top of said body of said guitar proximate said neck of said guitar;
d. two bottom supports extending away from said base of said first plate, wherein said two bottom supports are configured to extend down away from said base of said first plate and hook under said body of said guitar; and
e. wherein said second plate pivots away from said first plate such that when said stand is in use said second plate and said two bottom supports fully support said guitar in an upright position.
